(19) United States
(12) Patent Application Publication
(10) Pub. No.: US 2013/0017088 A1
(43) Pub. Date: Jan. 17, 2013

(54) VERTICAL AXIS MICRO WIND GENERATOR

(71) Applicant: Joseba Ariznabarreta, (US)

(72) Inventor: Joseba Ariznabarreta, (US)

(21) Appl. No.: 13/184,496

(22) Filed: Jul. 16, 2011

(51) Int. Cl. F03D 11/02

(52) U.S. Cl. 416/170 R

(57) ABSTRACT

A vertical axis micro wind generator is described, as comprising a Savonius type helical wing 1, (FIG. 1), two bearings 10a and 10b on each side of the the wing, a base 2 joined to wing 1 with shafts 7a, 7b and 7c protruding from the bottom side of base 2 where 3 bearings 9a, 9b and 9c, and planets 8a, 8b and 8c are located, a crown gear fixed to base plate 6 and a sun gear 12 rotating around shaft 3. Sun gear 12, joined to the magnets plate 4, rotates in the same direction as helical wing 1 and at a resultant speed as determined by the planetary gear system (FIG. 2).

The invention refers to a vertical axis micro wind generator (FIG. 1), of the type described in the 1st claim.

The specificity of the micro wind generator for which a patent is applied for, lies in the use of a planetary gear system (FIG. 2) located just below base 2 of wing 1 (FIG. 3) that transmits an increase of rotational speed from the wings to magnets plate 4, which, in turn, rotates over some magnet copper coils (FIG. 4).

Base 2 is joined to wings 1. The rotation of wings 1 by the drag of the wind incites on base 2. This rotation takes place around vertical shaft 3 with the aid of two bearings 10a and 10b located on both sides of wing 1 (FIG. 5). In the base 2 there are three planet gear shafts 7a, 7b and 7c and, inserted in each one of them, there is a planet gear 8a, 8b and 8c respectively.

Planet bearings 8^{a}, 8b and 8c rotate around shafts 7^{a}, 7b and 7c with the aid

With some non magnetic bearings 9a, 9b and 9c (FIG. 3), the planet bearings 8a, 8b and 8c rotate around the shafts 7a, 7b and 7c. The rings 15a, 15b and 15c screwed to the shafts 7a, 7b and 7c (FIG. 6) secure the planets 8a, 8b and 8c in place together with the bearings 9a, 9b and 9c.

The planetary gear system (FIG. 2) consists of a crown gear 11, planet gears 8a, 8b and 8c, and sun 12. The adopted conFig.tion in the micro wind generator that concerns us is fixed crown gear 11, rotational input in planet gears 8a, 8b and 8c—rotating in shafts 7a, 7b and 7c, and 3 simultaneously—and rotational movement output through sun gear 12.

The rotational speed relation between the input and the output is determined by:

[Øcrown+Øsun]/Øsun

Sun 12, which rotates in the shaft 3 with the aid of a bearing 13a is joined to the magnets plate 4 (FIG. 4). Connection between plate 4 and sun 12 is made through holes 14, which enable such joining. Crown 11 is screwed to ground-fixed lower base 6 (FIG. 4).

Sun 12 and magnets plate 4 rotate with the aid of bearings 13a and 13b, each located in a bore in sun 12 and bearing plate 4 respectively. Bearings 13a and 13b are screwed together and thus retained in place.

A nut screwed into the upper side of shaft 3 fixes the upper bearing 10a of wing 1, which ensures the correct placement of all components located in shaft 3.

### BRIEF DESCRIPTION OF THE DRAWINGS

FIG. 1 shows a perspective view of an assembly in accordance with an illustrative embodiment of the invention where the assembly is in its working configuration.

FIG. 2 shows a view of the planetary gear system, illustrating crown, planets and sun gears in mesh.

FIG. 3 shows a perspective view of the planetary gear system, where planets are inserted in shafts protruding from the blade joined base.

FIG. 4 shows a perspective view of the generator, where the crown is fixed to the outer case and the sun is fixed to the rotating magnets.

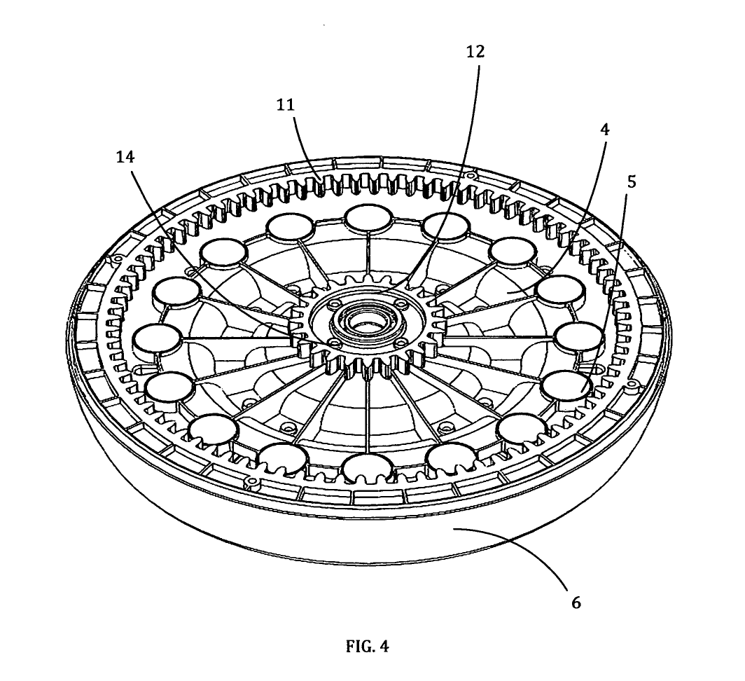

FIG. 5 shows a section view of the blade and co joined plate, with bearings inserted in the central tubular shaft and located in both the upper and lower ends of the blade.

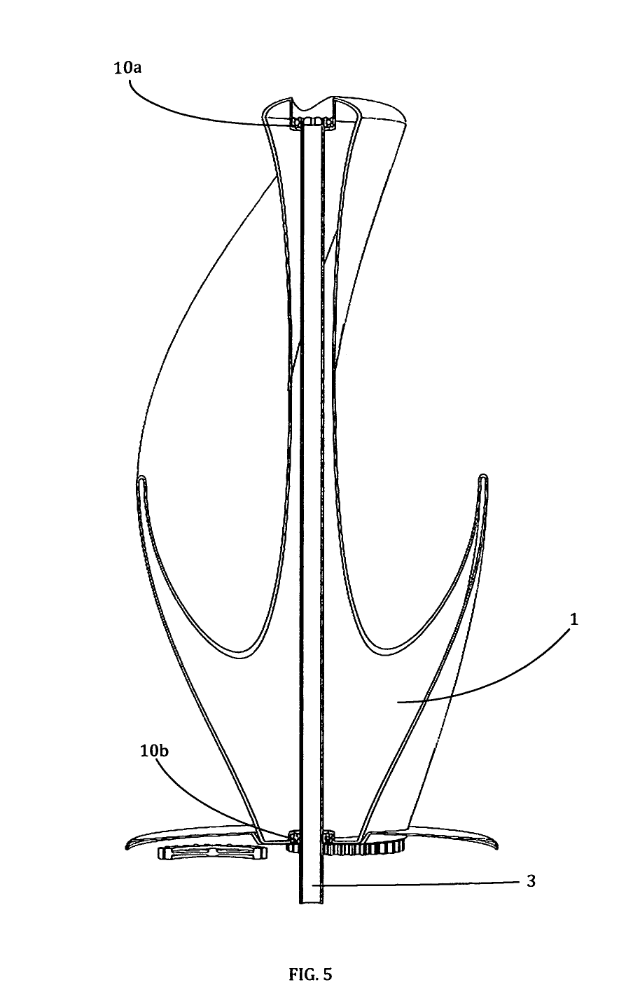

FIG. 6 shows a section view of a planet gear and its bearing inserted in the shaft protruding from the base co-joined to the blade.

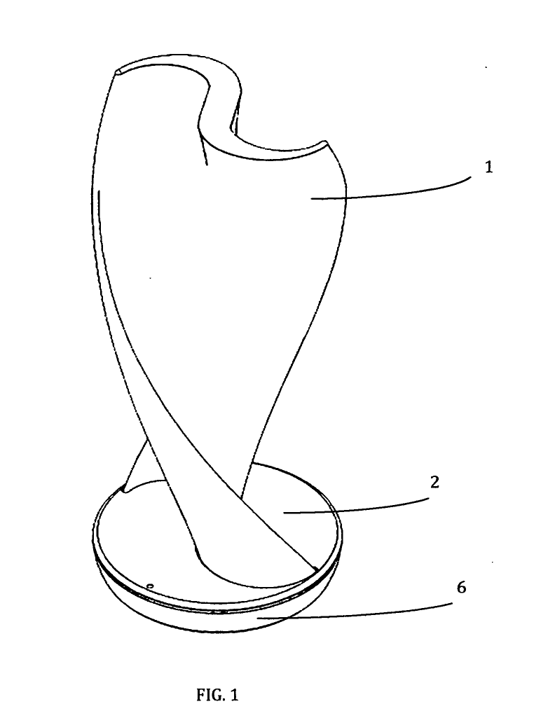

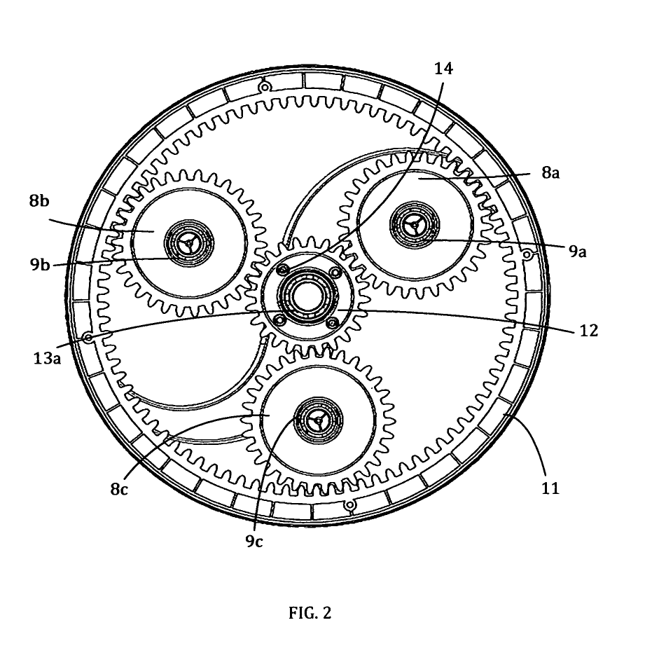

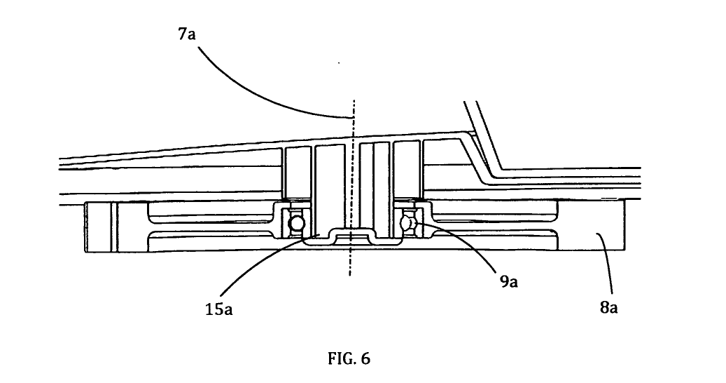

1. A vertical axis wind generator (FIG. 1), said wind generator comprising a helical wing 1, of the Savonius type, with bearings on both sides of wing 1, which rotates around shaft 3, a base 2 joined to wing 1, with shafts protruding from the bottom side of base 2, where bearings and gears are located, a crown gear 11 fixed to the lower base 6 and a sun gear 12 rotating around shaft 3, which make up the planetary gear system (FIG. 2). Sun 12, joined to a magnet plate 4, rotate in the same direction as wing 1 and at a resultant speed as determined by the planetary gear system.

2. Micro wind generator according to claim 1, said wind generator comprising a Savonius type hollow helical blade manufactured by rotomoulding process.

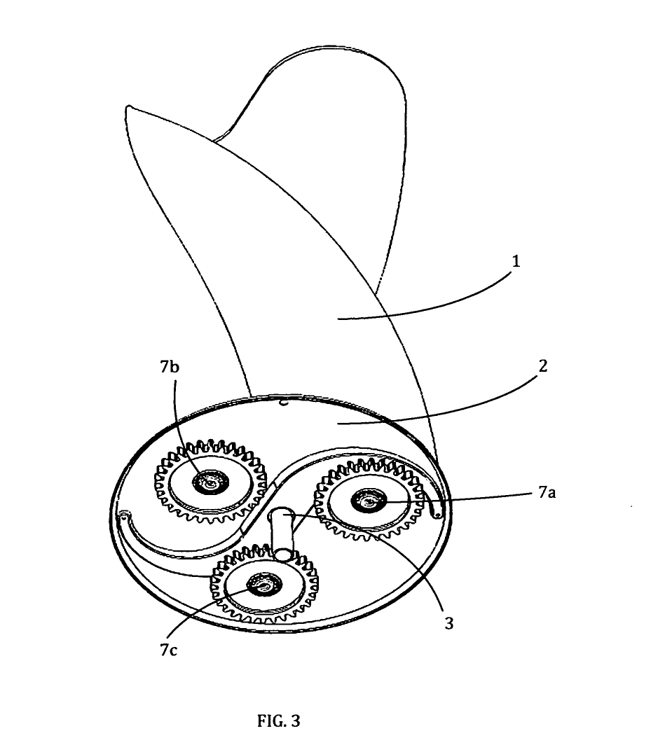

3. Micro wind generator according to claim 1, said wind generator comprising planets that rotate around shafts protruding from bottom side of base 2, joined to wing 1 (FIG. 3).

4. Micro wind generator according to claim 3, said wind generator comprising a sun 12 joined to magnets plate 4 and rotating around shaft 3.

5. Micro wind generator according to claim 4, said wind generator comprising shaft 3 fixed to base plate 6.

6. Micro wind generator according to claim 1, said wind generator comprising crown gear 11 (concentric to shaft 3) fixed to base plate 6.
